(19) United States
(12) Patent Application Publication
(10) Pub. No.: US 2007/0000092 A1
(43) Pub. Date: Jan. 4, 2007

(54) Rivet hinges and panel flanges

(76) Inventor: Kurt Geffe, Bellevue, WA (US)

Correspondence Address: Stephen M. Evans;GRAYBEAL JACKSON HALEY LLP, Suite. 350, 155-108th Avenue N.E., Bellevue, WA, 98004-5901, US

(21) Appl. No.: 11/414,735

(22) Filed: Apr. 27, 2006

Related U.S. Application Data
(60) Provisional application No. 60/675,943, filed on Apr. 27, 2005.

(51) Int. Cl. E05D 5/00

(52) U.S. Cl. 16/382

(57) ABSTRACT

Embodiments of the invention are directed to enclosure accessories, namely, mountable hinge assemblies or panel flanges for use with vertical single or double rivet angle or tee posts, as well as with single or double rivet angle, channel or “z” beams. Heretofore, shelving constructed from single or double rivet posts and beams has been open to casual visual inspection and subject to damage from the environment. Embodiments of the invention provide a convenient means for enclosing such spaces and establishing swing-door access opportunities.

### CROSS-REFERENCE TO RELATED APPLICATION

This is a utility application that claims benefit, under 35 USC §119 (e) to Provisional Patent Application Ser. No. 60/675,943, filed 27 Apr. 2005, which application is incorporated herein by reference.

### BACKGROUND OF THE INVENTION:

In the field of shelving and racks, and particularly in the field of industrial shelving and racks, it is common to use angle material for structural posts (uprights) and beams (cross members), as angle material represents the best compromise between material usage and load capacity. In such assemblies, four posts are generally linked to each other by connecting spanning beams so as to approximate an open-sided rectangular box form. In such environments, it is also desirable to provide means for varying the elevation of the actual shelves or horizontal supporting surfaces within the structure of the assembly. With certain prior art embodiments, the posts and beams are linked to each other using fasteners such as bolts and nuts. While effective, the process of assembly and disassembly is undesirably long. And when such fastening arrangements are used with respect to shelving, any change in shelf height results in additional time consuming actions.

As a partial solution to this drawback to convention fastener use, a common means for linking shelving to structural post or uprights relies upon beams or cross members possessing laterally extending rivets while the posts or uprights possess a plurality of equally spaced holes sized to removably accept the rivets. This type of shelving assembly is commonly referred to as rivet angle shelving. Each rivet is generally characterized as having a head portion and reduced diameter neck portion. The rivet slots or openings on the structural posts or uprights comprise an enlarged portion for receiving the rivet head, and a lower reduced width portion that can only receive the neck portion of the rivet. Thus, this “key hole” design retains an inserted rivet when the rivet is inserted into the enlarged portion of the opening and caused to occupy the reduced width portion of the opening.

As noted above, rivet shelving is an open frame design. There are no doors or sides as is the case with traditional cabinetry. Any items placed on the shelves of a rivet shelving system will be at least visually exposed. While in industrial settings such exposure may be tolerable or even desirable, it may not be desirable in consumer settings such as garages, mud rooms or pantries. And while skilled practitioners may apply conventional fasteners to panels and link the panels to the rivet shelving via the fasteners, such actions incur the undesirable consequences associated with non-rivet shelving mentioned above. Therefore, a need exists to provide convenient means for attaching panels and doors to rivet shelving without the need for conventional fasteners.

### SUMMARY OF THE INVENTION

The invention is directed to enclosure accessories, namely, mountable hinge assemblies or panel flanges for use with vertical single or double rivet angle or tee posts, as well as with single or double rivet angle, channel or “z” beams. Heretofore, shelving constructed from single or double rivet posts and beams has been open to casual visual inspection and subject to damage from the environment. The invention provides a convenient means for enclosing such spaces and establishing swing-door access opportunities.

Embodiments of the hinge assembly of the invention comprises a first plate or leaf and a second plate or leaf rotationally linked to one another through a pin or the like, as commonly accomplished by hinges, e.g., interleaving hollow cylinders (knuckles) formed from or extending from a pair of plates and secured by a pin. One leaf comprises at least one rivet member, and preferably at least two rivet members, extending from one surface thereof, and for convenient reference herein, is referred to as jamb leaf. The size and features of the jamb leaf are intentionally similar to other rivet members that may be found in related structure that integrates with the described posts and beams, although a functionally similar but structurally different physical form can be used. Rotationally linked to the jamb leaf is a second leaf, which may define at least one hole to permit a fastener to pass there through for use in securing a door panel. For convenient reference herein, this leaf is referred to as a door leaf.

Because the hinge assembly utilizes a mounting means equivalent in function to that of the structural members comprising a shelving structure, the hinge assemblies require no mounting tools other than those necessary for construction of the shelving structure, e.g., a dead blow hammer. When mounted to door panels and spaced such that the extending rivet members are in registry with the hole-slot features of the posts and/or beams, a user may simply insert and secure the hinged door panel to the shelving structure, thereby instantly creating a swing door.

The leafs of the hinge assemblies of embodiments of the invention may be substantially planar, or may incorporate an offset such that a mounted door panel fits generally flush with the shelving structure (e.g., wrap-around, concealed or semi-concealed hinge assembly). Moreover, offset door leaf embodiments structural support for heavy panels in the open position, as is known in the art. Any variety of hinge embodiments may be mounted to a door panel by any conventional means, such as mechanical fasteners including screws for blind-side installations or bolt and nut combinations, adhesives and/or similar means as is known to practitioners skilled in the art.

For added robustness, the jamb leaf may be configured to contact more than one surface of the shelving structure, e.g., a post. Thus, for example, if angle posts or beams are used, the jamb leaf may have two orthogonally oriented surfaces such that both surfaces contact the post or beam after engagement of the jamb leaf therewith. Additionally, in such embodiments both surfaces may comprise extending rivet members, again providing additional support and load distribution qualities to the hinge assembly.

Panel flange embodiments of the invention comprise a leaf portion having at least one rivet member extending from one surface thereof. The remaining portion(s) of the panel flange, such as a panel engaging portion, may be planar and mount to the non-exposed surface of the panel (reverse mount) whether at the edge of a panel or not, stepped to mount to the exterior of the panel at an edge thereof (step mount), or formed to fit and cradle the desired panel, such as a “U” shaped portion that wraps around an edge portion of the panel providing both a reverse and step mount feature (edge mount). When mounted, the spacing of the flanges on the panel are such that the extending rivet members are in registry with the hole-slot features of the posts and/or beams that comprise the shelving structure. As with the hinge assembly embodiments of the invention, the panel may be blind-side mounted or may be through bolted, depending upon design considerations, or may be adhered to the flange through the use of adhesives.

In view of the foregoing, the invention comprises at least one leaf having on at least one surface thereof at least one rivet extending orthogonally there from.

### BRIEF DESCRIPTION OF THE DRAWINGS

FIG. 1 is a partial perspective view of a rivet shelving system with a door and a panel attached thereto using hinge assembly and flanges embodiments of the invention;

FIG. 2 is an exploded perspective view of a hinge assembly embodiment of the invention and a vertical rivet angle post with the hinge being shown in the open position and, in phantom, in the closed position as indicated by the arrow;

FIG. 3 is a partial side elevation view of the hinge assembly and rivet angle post shown in FIG. 2, during insertion of an upper rivet member into the post, with the inserted position being shown in phantom;

FIG. 4 is a partial side elevation view of the hinge assembly and rivet angle post shown in FIG. 3, after insertion and engagement of an upper rivet member into the post;

FIG. 5 is a perspective view of a first panel flange embodiment of the invention with an associated panel shown in phantom;

FIG. 6 is a perspective view of a second panel flange embodiment of the invention with an associated panel shown in phantom; and

FIG. 7 is a plan view of an alternative hinge assembly embodiment where a second jamb leaf is orthogonal to a first jamb leaf, both having rivet members extending there from.

### DESCRIPTION OF EMBODIMENTS OF THE INVENTION

The following discussion is presented to enable a person skilled in the art to make and use the invention. Various modifications to the embodiment will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

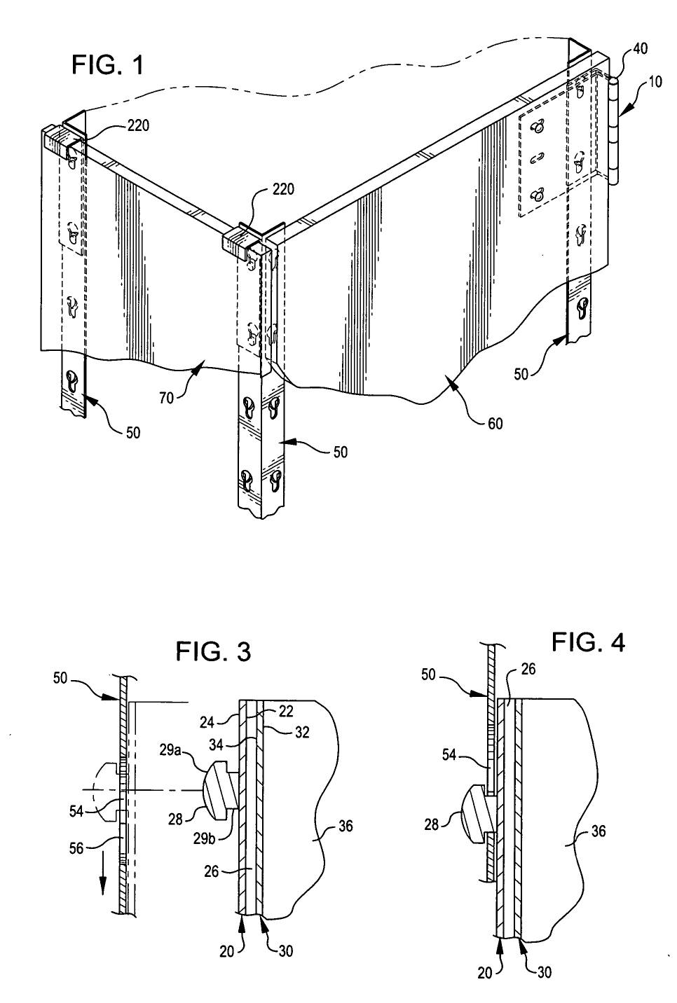

Turning then to the several figures wherein like numerals indicat like parts, and more particularly to FIG. 1, several embodiments of the invention are shown. FIG. 1 demonstrates a hinge assembly embodiment of the invention and a pair of flange embodiments of the invention attached to a rivet shelving system. In particular, hinge assembly 10 is shown attached to angle post 50 and carrying door panel 60, while panel flanges 220 is shown attached to angle post 50 and retaining panel 70 (the lower edge of panel 70 is carried by another pair of panel flanges 220 as is schematically shown in FIG. 6). While hinge assembly 10 and panel flanges 220 can be constructed from any durable and generally rigid material, mild steel is preferred.

Door panel 60 can be attached to hinge assembly 10 via mechanical fasteners extending from one side of door panel 60 to the other as shown, or by other means such as blind side fasteners and/or adhesives. Panel 70 can similarly be attached to flange 220 (or flange 120 as shown in FIG. 5) via mechanical fasteners extending from one side of panel 70 to the other, by means such as blind side fasteners and/or adhesives, or by gravity and/or interference fit as shown in this Figure and FIG. 6.

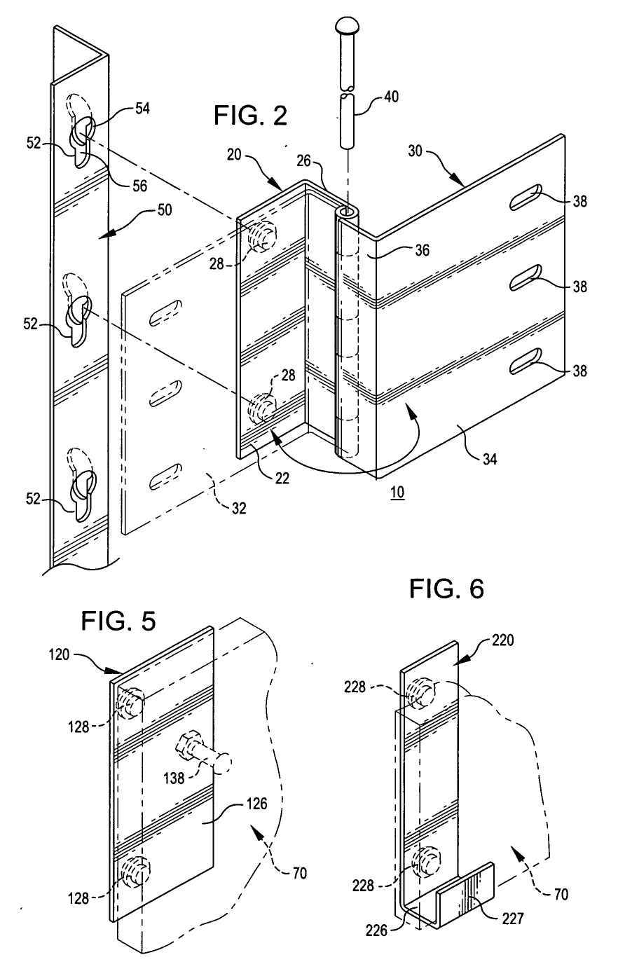

Turning next to FIG. 2, hinge assembly 10 is shown in greater detail. Each hinge assembly 10 comprises jamb leaf 20 and door leaf 30. Leaf 20 includes inside surface 22 and outside surface 24 (see FIG. 3), as well as return or step portion 26, which in the illustrated embodiment includes hinge knuckles. Similarly, leaf 30 includes inside surface 32 (see FIG. 3) and outside surface 34, as well as return or step portion 36. Means for mounting hinge 10 to a portion of the rivet shelving, such as post 50, comprises in the illustrated embodiment rivet member 28, which are also shown in FIGS. 3 and 4. Each rivet member 28 is preferably swage fitted to holes in leaf 20 or may be created by other means such as casting or welding. Leaf 30 defines a plurality of mounting holes 38, which can receive fasteners for mounting door panel 60, as is shown in FIG. 1.

In the illustrated embodiment, hinge assembly 10 includes return or step portions 26 and 36, which provide two distinct advantages. The first advantage is that the bulk of leafs 20 and 30 are concealed from view when installed. The second advantage is that a portion of surface 32 of step portion 36 is in compressive contact with an edge portion of door panel 60. This compressive contact reduces the stress occurring at holes 38 and corresponding holes in door panel 60 when panel 60 is mounted to hinge assembly 10, as persons skilled in the art will appreciate.

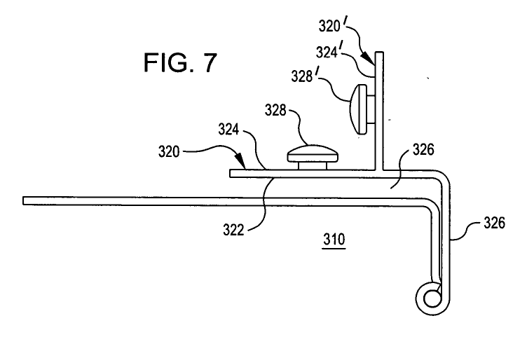

FIGS. 3 and 4 best illustrate the convenient mounting of various embodiments of the invention to an appropriately constructed rivet hole material, such as post 50. As shown, each rivet member 28 extending from leaf 20 has a head 29a and a reduced diameter body 29b. Each hole 52 (see FIG. 2) includes generally round hole portion 54 and elongated slot portion 56. As is well known in the art, the diameter of hole portion 54 is slightly greater than that of head 29a and the width dimension of slot portion 56 is slightly wider than the diameter of body 29b, but is less than the diameter of head 29a. Thus, a user can insert rivet member 28 into hole portion 54 so that head 29a passes there through, and then translate rivet member 28 so that body 29b occupies slot portion 26. This sequence of steps is best shown in FIGS. 3 and 4. Once inserted, lateral movement of hinge assembly 10 is resisted by the interference between rivet head 29aand post 50, as well as surface 24 and post 50. [25] While the previously described door hinge assemblies have only a single surface interface with the shelving structure, the embodiment shown in FIG. 7 provides for two such surfaces, which may be desirable in certain high load environments. As shown, hinge assembly 310 is nearly identical to hinge assembly 10, but includes second jamb leaf 320′. As shown in this plan view, jamb leaf 320′ has inside surface 322′ and outside surface 324′, as well as rivet members 328′. As those persons skilled in the art will appreciate, numerous alternative embodiments exist, which depend upon the desired strength of the hinge assembly, the mounting interface, fitment with other components and the like.

The concept of flange fittings for rivet shelving extends beyond hinge assemblies, as is demonstrated in FIGS. 1, 5 and 6. Here, several panel mounting flanges are shown. Mounting flange 110 comprises plate 120, having outside surface 126 and inside surface 124 (hidden from view), from which extend rivet members 128; mounting flange 210 comprises plate 220, having outside surface 226 and inside surface 124 (hidden from view), from which extend rivet members 228. Mounting flange 110 further includes a hole through which a fastener system, such as bolt and nut combination 138 may pass. When secured through ordinary means, panel 70 can be securely fastened to mounting flange 110. By attaching at least a pair of mounting flanges 110 to panel 70, a user can conveniently, securely and removably attach panel 70 to a rivet shelving structure.

While mounting flange 110 requires the use of a fastener to associate it with panel 70, mounting flange 210 uses a clip arrangement. As shown in FIGS. 1 and 6, mounting flange 210 further comprises leg 226 and return 227, thus forming a “U” shaped receiver for an edge of panel 70. Preferably a friction fit exists between mounting flange 210 and panel 70, although such a quality is not necessary for the functionality of the mounting flange. Also as demonstrated in the drawings, if panel 70 is appropriately dimensioned, mounting flange 210 can be used for both upper and lower support positions.

What is claimed:

1. A hinge assembly for use in a rivet shelving system comprising:
a first leaf having a first surface and an opposing second surface where one of the first surface or the second surface includes an extending rivet member; and
a second leaf having a first surface and an opposing second surface wherein the second leaf is rotationally coupled to the first leaf.

2. The hinge assembly of claim 1 further comprising a second rivet member extending from the same surface as the first rivet member.

3. The hinge assembly of claim 1 wherein the first and second leaves are rotationally coupled by a knuckle and pin arrangement.

4. The hinge assembly of claim 1 wherein the first leaf includes a step or return portion and the second leaf includes a complementary step or return portion such that the return portions nest when the first and second leaf are brought into a proximate relationship.

5. The hinge assembly of claim 1 wherein the second leaf defines at least one hole for receiving a fastener.

6. The hinge assembly of claim 1 further comprising a second jamb leaf, extending substantially orthogonally from the first jamb leaf, and having a first surface and an opposing second surface.

7. The hinge assembly of claim 6 where one of the first surface or the second surface includes a second rivet member extending orthogonally to the first rivet member.

8. A flange for linking a panel to a rivet shelving system comprising:
a plate member having a first surface and an opposing second surface where one of the first surface or the second surface includes an extending rivet member and the plate member defines at least one hole for receiving a fastener.

9. The flange of claim 8 further comprising a second rivet member extending from the same surface as the first rivet member.

10. The flange of claim 8 wherein the plate member includes an extending portion which extends substantially orthogonally from the plate member and a return member extending from the extending portion to form a plane substantially parallel to the plate member.
